(19) United States
(12) Patent Application Publication
(10) Pub. No.: US 2020/0065183 A1
(43) Pub. Date: Feb. 27, 2020

(54) METHOD FOR DETERMINING AND OPTIMIZING TIMING SPECIFICATIONS FOR AN INTEGRATED CIRCUIT

(71) Applicant: GLOBALFOUNDRIES Singapore Pte. Ltd., Singapore (SG)

(72) Inventors: Yin Hong CHAN, Singapore (SG); Szu Huat (Wu Shifa) GOH, Singapore (SG); Jeffery Chor-Keung LAM, Singapore (SG)

(21) Appl. No.: 16/112,065

(22) Filed: Aug. 24, 2018

(51) Int. Cl. G06F 11/07

(52) U.S. Cl. CPC G06F 11/0793; G06F 11/076

(57) ABSTRACT

A Method of determining a suitable integrated circuit (IC) timing specifications margin by considering the dynamic nature of pin-to-pin interactions in an automated manner is disclosed. Embodiments include initializing one or more sets of timing specification on one or more pins of an IC, wherein each set of timing specification has a plurality of variables; determining one or more error count (EC) for the IC within the one or more sets of timing specification based, at least in part, on total number of failed cycles; ranking the one or more sets of timing specification based, at least in part, on the one or more EC; and replacing at least one lowly ranked set of timing specification with at least one new set of timing specification.

### TECHNICAL FIELD

The present disclosure generally relates to integrated circuits (ICs), and more specifically, to timing specifications of an IC.

### BACKGROUND

Technology scaling is widening the gap between the expected timing of a digital circuit and actual silicon (Si) performance. Achieving an ideal timing closure in modern system-on-chip (SoC) is difficult for several reasons. For example: (a) process variations in device and interconnect; (b) crosstalk due to coupling wire capacitances; (c) increased complexity in timing requirements due to multiple input-output (IO) protocols; and (d) differences in testing environment. Currently, a pin margin analysis, which is fundamentally a one-dimensional shmoo, may be implemented to evaluate the timing margins of each IO pin. Similarly, a two-dimensional shmoo analysis may be employed to study the test margin resulting from the interactions between two variables. However, these processes are manual, sequential, and time-consuming, resulting in low productivity. Further, these processes disregard pin interactions-induced timing shifts as a result of more than two variables.

A need, therefore, exists for a comprehensive method to debug IC timing specifications on real Si by determining a suitable IC timing specification based on zero failing cycles in an automated manner.

### SUMMARY

An aspect of the present disclosure is a method for determining a suitable IC timing specifications margin by considering the dynamic nature of pin-to-pin interactions in an automated manner.

Another aspect of the present disclosure is an apparatus that automatically considers the dynamic nature of pin-to-pin interactions while determining a suitable IC timing specifications margin.

According to the present disclosure, some technical effects may be achieved in part by a method including: initializing one or more sets of timing specification on one or more pins of an IC, wherein each set of timing specification has a plurality of variables; determining one or more error count (EC) for the IC within the one or more sets of timing specification based, at least in part, on total number of failed cycles; ranking the one or more sets of timing specification based, at least in part, on the one or more EC; and replacing at least one lowly ranked set of timing specification with at least one new set of timing specification.

Another aspect of the present disclosure is a method including initializing one or more sets of timing specification on one or more pins of an IC, wherein each set of timing specification has a plurality of variables; determining one or more EC for the IC within the one or more sets of timing specification based, at least in part, on total number of failed cycles; ranking the one or more sets of timing specification based, at least in part, on the one or more EC; identifying two highly ranked sets of timing specification from the ranking; generating at least one new set of timing specification based on the two highly ranked sets of timing specification; and replacing at least one lowly ranked set of timing specification with the at least one new set of timing specification, wherein replacing the at least one lowly ranked set of timing specification is dynamic.

A further aspect of the present disclosure is an apparatus including at least one processor, and at least one memory including computer program code for one or more computer programs, the at least one memory and the computer program code configured to, with the at least one processor, cause, at least in part, the apparatus to initialize one or more sets of timing specification on one or more pins of an IC, wherein each set of timing specification has a plurality of variables; determine one or more EC for the IC within the one or more sets of timing specification based, at least in part, on total number of failed cycles; rank the one or more sets of timing specification based, at least in part, on the one or more EC; and replace at least one lowly ranked set of timing specification with at least one new set of timing specification.

The apparatus is also caused to identify two highly ranked set of timing specification from the ranking; and generate the at least one new set of timing specification based on the two highly ranked set of timing specification. The apparatus is further caused to generate one or more random number from 1 to 10 for the plurality of variables in the at least one new set of timing specification; and execute a crossover, a mutation or retainment of variables of the at least one new set of timing specification based, at least in part, on at least one random number.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 is a diagram of an automatic test equipment (ATE) in contact with a wafer, in accordance with an exemplary embodiment;

FIG. 2 is a flowchart of a process for accessing and ranking one or more sets of timing specification on one or more pins of an IC, in accordance with an exemplary embodiment;

FIG. 3 is a flowchart of a process for reproduction operations involving each of the variables of the two highly ranked sets of timing specification, in accordance with an exemplary embodiment;

FIG. 4 is a diagram wherein a plurality of die of a wafer is selected for machine learning to account for performance related to wafer signature, in accordance with an exemplary embodiment; and

FIG. 5 is a diagram that illustrates the reproduction process for two highly ranked sets of timing specification, in accordance with an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves problems relating to multiple pin interactions-induced timing shifts and low productivity attendant upon a manual, sequential, and time-consuming mode of testing on timing specifications. The problem is solved, inter alia, by an efficient automated method that determines suitable IC timing specification based on zero failing cycles.

Methodology in accordance with embodiments of the present disclosure includes initializing one or more sets of timing specification on one or more pins of an IC, wherein each set of timing specification has a plurality of variables. Methodology in accordance with embodiments of the present disclosure also includes: determining one or more EC for the IC within the one or more sets of timing specification based, at least in part, on total number of failed cycles; ranking the one or more sets of timing specification based, at least in part, on the one or more EC; and replacing at least one lowly ranked set of timing specification with at least one new set of timing specification.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

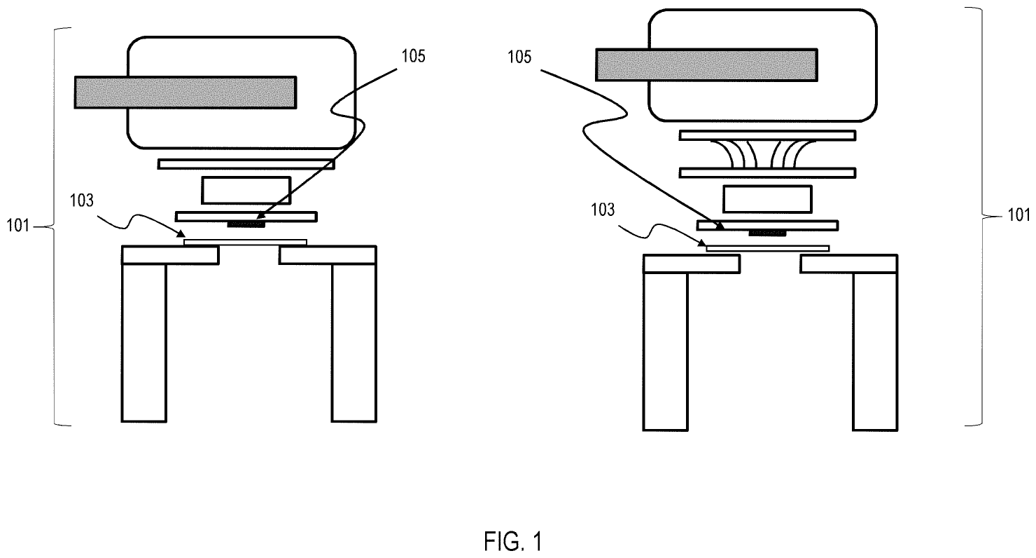

FIG. 1 is a diagram of an automatic test equipment (ATE) in contact with a wafer, in accordance with an exemplary embodiment. In one instance, a genetic algorithm (GA)-based machine learning approach is implemented in a central processing unit (CPU) of the ATE 101 for an automated IC digital circuit timing optimization. In one instance, the algorithm is not limited to the GA-like search algorithms. In another instance, GA is a metaheuristics method that is capable of accepting a temporary deterioration of a solution to enable a thorough exploration of the entire solution space, to achieve close to global optimum. This is accomplished by applying operators such as crossover or mutation to an intermediate solution to escape from being trapped in local optimal(s) when solving problems. In a further instance, GA includes any system modification and analysis methods that make use of big data, machine learning and stochastic search methods for IC timing specification analysis on Si. In one instance, optimization is a process of searching for the best possible solution based on a starting data point.

Referring to FIG. 1, a wafer 103 placed underneath the probe pins 105 of a probe card has two sides, the front side has the electrical pads for contact with the internal circuits and the reverse side (also known as the substrate side) is a perfect mirror reflective surface. The probe pins 105 of the ATE 101 then electrically contacts the pads of each die within front side of the wafer 103. The ATE 101 may determine time-critical pins and identify wrong timing conditions on the critical pins based, at least in part, on user input or hardware-induced marginalities on the time critical pins. In this instance, dies at different wafer zones are selected for machine learning to account for performance related to wafer signature. In another instance, a user-defined script may be implemented to generate a specified testing setting and may be translated into a code or an algorithm for ATE 101 to execute.

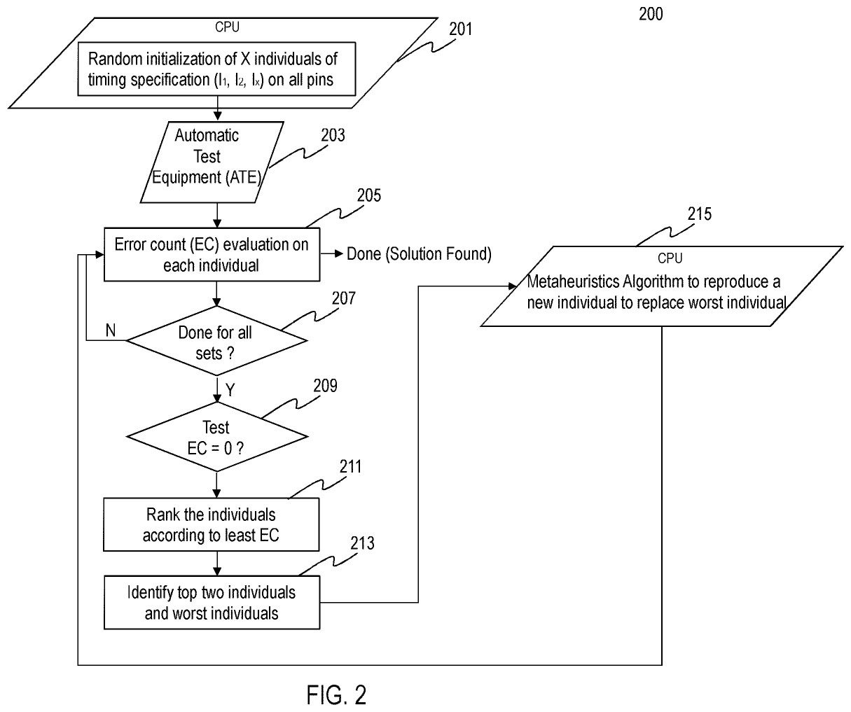

FIG. 2 is a flowchart of a process for accessing and ranking one or more sets of timing specification on one or more pins of an IC, in accordance with an exemplary embodiment. In one instance, a GA based machine learning approach implemented in a CPU of an ATE may perform process 200.

In step 201, a plurality of set of timing specification on all pins of an IC are randomly initialized by ATE 203. In one instance, at least 100 sets of timing specification, e.g., referred to as candidates or individual, are randomly initialized on a single die. In one instance, each set of timing specification includes a plurality of variables. In another instance, a variable is the driving (rise or fall) and comparing edge of all IO as a percentage of a test period. These variables can either be randomly initialized or be constrained to a stipulated range around the vicinity of a default setting.

In step 205, ATE 203 determines an EC for the IC within the plurality of set of timing specification based, at least in part, on the total number of failed cycles. In one instance, the ATE 203 evaluates candidates or individuals based, at least in part, on the EC. In one instance, ATE 203 implements a combination of test setup and stochastic search method for timing specification analysis. In another instance, the criterion for evaluation of a test response based on EC is not limited to the number of failed cycles.

In step 207, ATE 203 tests and evaluates EC on all sets of timing specification and determines whether the EC on the tested and evaluated sets of timing specification is zero (step 209). In one instance, multiple iterations are required to achieve a zero EC to determine a possible timing specification solution. Thereafter, in step 211, the plurality of set of timing specification are ranked in an ascending order based, at least in part, on the total number of EC.

In step 213, ATE 203 identifies two highly ranked sets of timing specification and one or more lowly ranked sets of timing specification from the ranking. Then, in step 215, a new set of timing specification is generated by reproducing the two highly ranked sets of timing specification. In one instance, the new set of timing specification is generated to replace the lowly ranked sets of timing specification.

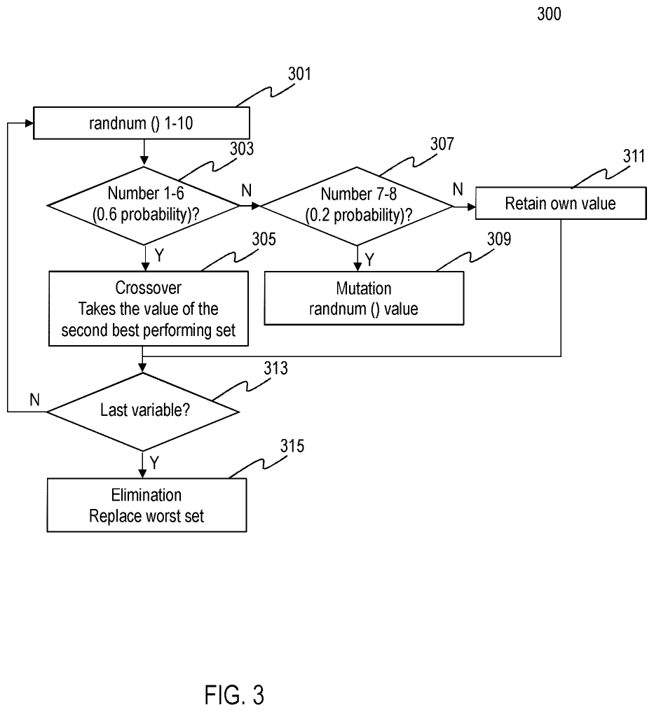

FIG. 3 is a flowchart of a process for reproduction operations involving each of the variables of the two highly ranked sets of timing specification, in accordance with an exemplary embodiment. In one instance, a GA based machine learning approach implemented in a CPU of an ATE may perform process 300.

In step 301, a random number from 1 to 10 is generated for executing a crossover, a mutation or retainment of variables for a new set of timing specification, rather than simply adopting the variables of the two highly ranked sets of timing specification as the new set of timing specification.

In step 303, at least one random number is determined to be within a range of 1 to 6, e.g., a probability of 0.6. A crossover process is implemented whereupon the variables of the new set of timing specification take after the value of a second highly ranked set of timing specification from the ranking (step 305).

In step 307, at least one random number is determined to be within a range of 7 to 8, e.g., a probability of 0.2. A mutation process is implemented whereupon a different variable is generated for the new set of timing specification (step 309).

In step 311, at least one random number is determined to within a range of 8 to 9, whereupon the new set of timing specification retains variables of a first highly ranked set of timing specification from the ranking. This process of generating a random number from 1 to 10 is performed on all the variables the new set of timing specification (step 313). Thereafter, in step 315, one or more lowly ranked set of timing specification is replaced with a new set of timing specification.

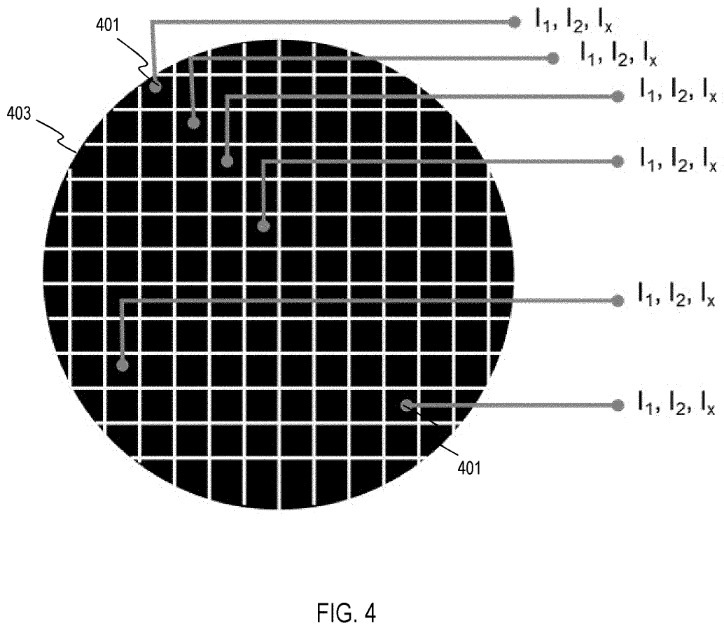

FIG. 4 is a diagram wherein a plurality of die of a wafer is selected for machine learning to account for performance related to wafer signature, in accordance with an exemplary embodiment. In one instance, each die 401 of wafer 403 that is selected for machine learning includes a set of timing specification, and each set of timing specification includes a plurality of variables, e.g., 1₁, 1₂ . . . 1ₓ. In one instance, at least 25% of the gross dies per wafer (GDPW) and across different regions on the wafer 403 are selected to provide a reasonably big number for sufficient generalization. In another instance, wafers of a plurality of ICs may be tested to determine an optimal set of timing specification for each IC, e.g., testing at least 50 ICs to obtain 50 solutions. Thereafter, at least one best set of timing specification may be selected from the optimal set of timing specification, e.g., selecting the best solution from 50 different optimal solutions.

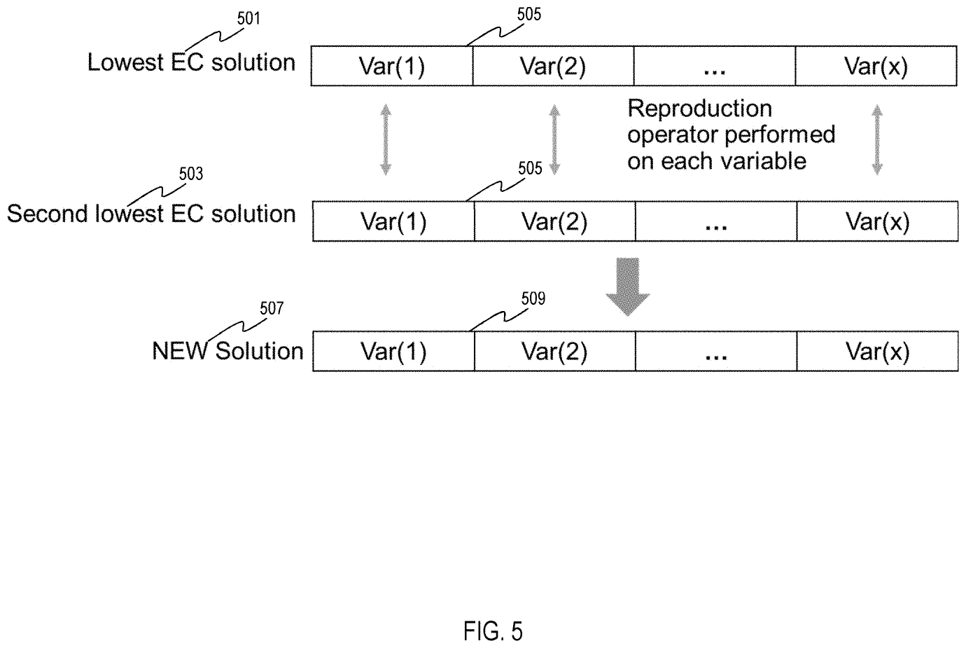

FIG. 5 is a diagram that illustrates the reproduction process for two highly ranked sets of timing specification, in accordance with an exemplary embodiment. In one instance, two sets of timing specification 501 and 503 with the lowest EC are selected from the ranking. These two sets of timing specification 501 and 503 include a list of timing variables 505, e.g., Var (1) . . . Var (x). Then, a reproduction process is performed on each of the variables to generate a new set of timing specification 507 including a new list of timing variables 509. The optimization process terminates once timing specification with zero EC is obtained.

The embodiments of the present disclosure can achieve several technical effects, such as a dynamic, robust and automated solution in managing pin-to-pin interactions and refining timing specifications. In addition, the present method results in yield improvement from false fail occurrences and hence, a more stable chip performance evaluation. Further, the present method overcomes the current limitation, e.g., technique gap, of sequential assessment of timing specifications. Devices formed in accordance with embodiments of the present disclosure enjoy utility in various industrial applications, e.g., microprocessors, smartphones, mobile phones, cellular handsets, set-top boxes, DVD recorders and players, automotive navigation, printers and peripherals, networking and telecom equipment, gaming systems, and digital cameras. The present disclosure, therefore, enjoys industrial applicability in any of various types of highly integrated semiconductor devices and ICs.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
initializing one or more sets of timing specification on one or more pins of an integrated circuit (IC), wherein each set of timing specification has a plurality of variables;
determining one or more error count (EC) for the IC within the one or more sets of timing specification based, at least in part, on total number of failed cycles;
ranking the one or more sets of timing specification based, at least in part, on the one or more EC; and
replacing at least one lowly ranked set of timing specification with at least one new set of timing specification.

2. The method according to claim 1, further comprising:
identifying two highly ranked sets of timing specification from the ranking; and
generating the at least one new set of timing specification based on the two highly ranked sets of timing specification.

3. The method according to claim 2, further comprising:
generating one or more random number from 1 to 10 for the plurality of variables; and
executing a crossover, a mutation or retainment of variables of the at least one new set of timing specification based, at least in part, on at least one random number.

4. The method according to claim 3, further comprising:
determining the at least one random number is within a range of 1 to 6; and
causing the variables of the at least one new set of timing specification to take after value of a second highly ranked set of timing specification based, at least in part, on the determination.

5. The method according to claim 3, further comprising:
determining the at least one random number is within a range of 7 to 8; and
generating a different variable for the at least one new set of timing specification based, at least in part, on the determination.

6. The method according to claim 3, further comprising:
determining the at least one random number is within a range of 8 to 9; and
causing the at least one new set of timing specification to retain variables of a first highly ranked set of timing specification based, at least in part, on the determination.

7. The method according to claim 1, further comprising:
ranking the one or more sets of timing specification in an ascending order based, at least in part, on total number of EC.

8. The method according to claim 1, further comprising:
testing the IC within the one or more sets of timing specification for the one or more EC until the one or more EC is zero.

9. The method according to claim 8, further comprising:
testing a plurality of IC to determine an optimal set of timing specification for each IC; and
selecting at least one set of timing specification from the optimal set of timing specification.

10. The method according to claim 1, wherein at least 100 sets of timing specification on one or more pins of the IC are initialized.

11. A method comprising:
initializing one or more sets of timing specification on one or more pins of an integrated circuit (IC), wherein each set of timing specification has a plurality of variables;
determining one or more error count (EC) for the IC within the one or more sets of timing specification based, at least in part, on total number of failed cycles;
ranking the one or more sets of timing specification based, at least in part, on the one or more EC;
identifying two highly ranked sets of timing specification from the ranking;
generating at least one new set of timing specification based on the two highly ranked sets of timing specification; and
replacing at least one lowly ranked set of timing specification with the at least one new set of timing specification, wherein replacing the at least one lowly ranked set of timing specification is dynamic.

12. The method according to claim 11, further comprising:
generating one or more random number from 1 to 10 for the plurality of variables; and
executing a crossover, a mutation or retainment of variables of the at least one new set of timing specification based, at least in part, on at least one random number.

13. The method according to claim 12, further comprising:
determining the at least one random number is within a range of 1 to 6; and
causing the variables of the at least one new set of timing specification to take after value of a second highly ranked set of timing specification based, at least in part, on the determination.

14. The method according to claim 12, further comprising:
determining the at least one random number is within a range of 7 to 8; and
generating a different variable for the at least one new set of timing specification based, at least in part, on the determination.

15. The method according to claim 12, further comprising:
determining the at least one random number is within a range of 8 to 9; and
causing the at least one new set of timing specification to retain variables of a first highly ranked set of timing specification based, at least in part, on the determination.

16. The method according to claim 11, further comprising:
ranking the one or more sets of timing specification in an ascending order based, at least in part, on total number of EC.

17. The method according to claim 11, further comprising:
testing the IC within the one or more sets of timing specification for the one or more EC until the one or more EC is zero.

18. An apparatus comprising:
at least one processor; and
at least one memory including computer program code for one or more programs,
the at least one memory and the computer program code configured to, with the at least one processor, cause the apparatus to perform at least the following,
initialize one or more sets of timing specification on one or more pins of an integrated circuit (IC), wherein each set of timing specification has a plurality of variables;
determine one or more error count (EC) for the IC within the one or more sets of timing specification based, at least in part, on total number of failed cycles;
rank the one or more sets of timing specification based, at least in part, on the one or more EC; and
replace at least one lowly ranked set of timing specification with at least one new set of timing specification.

19. The apparatus of claim 18, wherein the apparatus is further caused to:
identify two highly ranked set of timing specification from the ranking; and
generate the at least one new set of timing specification based on the two highly ranked set of timing specification.

20. The apparatus of claim 19, wherein the apparatus is further caused to:
generate one or more random number from 1 to 10 for the plurality of variables in the at least one new set of timing specification; and
execute a crossover, a mutation or retainment of variables of the at least one new set of timing specification based, at least in part, on at least one random number.
